(19) United States
(12) Patent Application Publication
(10) Pub. No.: US 2009/0151745 A1
(43) Pub. Date: Jun. 18, 2009

(54) Low-Fibrillation Molded Body

(75) Inventors: Helmut Padinger, Vocklamarkt (AT); Bernd Wagner, Timelkam (AT); Gerlinde Holzleithner, Seewalchen (AT)

Correspondence Address: FITZPATRICK CELLA HARPER & SCINTO, 30 ROCKEFELLER PLAZA, NEW YORK, NY, 10112, US

(73) Assignee: Lenzing Plastice GmbH, Lenzing (AT)

(21) Appl. No.: 12/093,080

(22) PCT Filed: Nov. 8, 2006
(86) PCT No.: PCT/AT2006/000455

§ 371 Date: Oct. 27, 2008

(30) Foreign Application Priority Data
Nov. 9, 2005 (AT) A 1834/2005

(51) Int. Cl. A61C 15/04; B29C 53/02

(52) U.S. Cl. 132/321; 156/200

(57) ABSTRACT

The invention relates to a low-fibrillation molded body containing a tape (1) essentially consisting of polytetrafluoroethylene, characterized in that the tape is composed of at least four plies (7,8,9,10) of essentially equal width arranged essentially parallel to each other, said plies being obtainable by folding.

### BACKGROUND OF THE INVENTION

### Field of the Invention

The invention relates to a low-fibrillation molded body containing polytetrafluoroethylene (PTFE), a process for the manufacture thereof as well as its use as a dental floss.

Tapes of PTFE are used, among other things, as a dental floss in the field of dental care, since PTFE is softer and smoother than, e.g., polyamide and, thus, there is a lower risk of injury to the gums. Further fields of application are medicine and technology, e.g., as a material for seals.

The basic process for the manufacture of the films used for producing the tapes is known, for example, from AT-B 370.673, GB-A 2 035 835 and EP-A 0 391 887.

Dental flosses made of PTFE tapes are described, for example, in EP 0 335 466, U.S. Pat. No. 4,776,358, U.S. Pat. No. 5,209,251 and U.S. Pat. No. 5,220,932.

However, as a result of the manufacturing process, PTFE tapes are prone to fibrillation, i.e., splitting of individual fibres. This causes problems either already when the dental floss is unwound from the dispenser or, respectively, when the dental floss splices during use and leaves residues between the teeth.

In AT-B 408.766, a process for the manufacture of a low-fibrillation dental floss is described, wherein a pre-molded body made of PTFE is twisted and subsequently pressed flat.

Apart from the introduction of filling materials (see, e.g., AT-B 399 882), a coating of said molded bodies is possible as well.

For many applications, especially in the dental floss sector, a uniform thickness-width dimension of the tape, and, as a consequence, of the final product, respectively, is advantageous and desirable. Such tapes are basic requirements for a metered application of coatings as well as for subsequent treatment processes which require precise yarn dimensions. At the same time, a minimum susceptibility to fibrillation is a basic requirement for many technical, medical and textile applications.

PTFE tapes are known from the prior art the edges of which are partially folded in the final processing stage. U.S. Pat. No. 4,776,358 describes a dental floss during the manufacture of which a tooth-cleaning agent is applied to a PTFE tape and the tape is subsequently folded across its entire width.

However, as is shown in U.S. Pat. No. 5,518,012, the folded tapes that are known have irregular properties with respect to the width and thickness of the tape and also leave a lot to be desired with regard to the fibrillation properties. Therefore, U.S. Pat. No. 5,518,012 proposes a comparatively thick unfolded PTFE tape having essentially uniform thickness-width dimensions. However, with regard to the manufacturing technique, unfolded tapes are often desirable only to a limited extent because of the comparatively large thickness that is required (thorough heating, better control of a wider and thinner film).

Furthermore, ready-made unfolded tapes also have disadvantages: although the tendency toward fibrillation has been partially improved as compared to tapes folded in a conventional manner, the external cutting edges still constitute a substantial risk of fibrillation.

Especially in dental floss applications, but also in medical and technical special applications, fibrils constitute a substantial risk during use and are therefore unacceptable. Nevertheless, the PTFE tapes should exhibit cross-sectional dimensions as uniform as possible.

### SUMMARY OF THE INVENTION

It is the object of the present invention to provide a process for the manufacture of low-fibrillation, folded PTFE tapes having regular cross-sectional dimensions.

Said object is achieved by a low-fibrillation molded body containing a tape essentially consisting of polytetrafluoroethylene, which molded body is characterized in that the tape is composed of at least four plies of essentially equal width arranged essentially parallel to each other, said plies being obtainable by folding.

### BRIEF DESCRIPTION OF THE FIGURES

Other features and advantages of the invention will emerge for the description given hereinafter with reference to the attached figures which, by way of non-limiting example, show some embodiments of the subject matter of the invention.

FIGS. 1-5 sequentially show an exemplary process according to the invention;

FIG. 6 shows a cross-section of an exemplary molded body according to the invention;

FIG. 7 shows a cross-section of another exemplary molded body according to the invention;

FIG. 8 shows a plan view of an exemplary device for manufacturing a molded body according to the invention; and

FIG. 9 shows a side view of the exemplary device of FIG. 8.

### DETAILED DESCRIPTION OF THE INVENTION

The term “containing” is understood to mean that, in addition to the tape of PTFE, the molded body according to the invention may contain further layers of a material, in particular a wax coating of the PTFE tape.

As opposed to the unfolded tape of U.S. Pat. No. 5,518,012, the invention thus provides a molded body which, due to an at least four-ply structure obtained by folding, meets both the requirements with regard to fibrillation resistance and those with regard to a uniform width and thickness.

As will be explained in more detail below, due to the precise folding of the tape, the originally external edges of the unfolded tape, which are particularly susceptible to fibrillation, are located in the interior of the molded body according to the invention. The new edges of the tape which have been formed as a result of folding are far less susceptible to fibrillation.

The PTFE tape of the molded body according to the invention may be composed of at least eight plies, which is achievable by refolding a four-ply tape.

A further aspect of the present invention relates to a low-fibrillation molded body containing a tape essentially consisting of polytetrafluoroethylene, which molded body is characterized in that the tape is folded on both edges and, in the folded state, both edges are located close to or at the longitudinal axis of the tape. The tape is thus double-ply.

Also in this embodiment of the molded body according to the invention, the original edges of the tape, which are susceptible to fibrillation, are thus no longer located on the outside, but on the surface of the tape close to the longitudinal axis of the tape. However, due to the specific precise folding, a constant thickness and width of the tape is also ensured—as opposed to previously known tapes produced by folding.

In a preferred embodiment, the individual plies of the tape are composed of at least two layers which, optionally, are coloured differently. By providing different layers, irregularities possibly existing in the tape can be levelled out better.

If, moreover, the layers are coloured differently, an additional advantage arises: When the molded body is used as a dental floss, the effect occurs that the inner colouring shines through so that it is obvious that the dental floss has already been used in that spot.

The molded body according to the invention is advantageously characterized in that the tape exhibits an essentially uniform width and thickness across its length. This is possible due to the precise folding of the tape, as was already mentioned above and will be described in detail below.

A new process serves for the manufacture of the molded body according to the invention, wherein, unlike in the prior art, a defined and precise folding of a PTFE tape is performed.

The process according to the invention comprises the steps of

a) providing a tape essentially consisting of polytetrafluoroethylene, which tape has two original edges,

b) folding the tape on both original edges so that, after the folding, the original edges end up lying essentially parallel to each other and close together, preferably adjacent to each other, and two new edges are formed,

c) optionally at least one further folding at the longitudinal axis of the tape so that, after the folding, the previously formed new edges end up lying essentially on top of each other.

The process according to the invention is preferably carried out such that, in step b), the original edges (2,3) end up lying close to or at the longitudinal axis (6) of the tape (1) after the folding.

If the process according to the invention is finished after step b) (so that, thus, no further folding step is performed), the above-described double-ply tape results in which, however, the original edges are no longer located on the outside, but on the surface of the tape close to the longitudinal axis of the tape and thus no fibrillation occurs when the tape is used.

Step c) may optionally be repeated several times. If step c) is carried out once, the result is a four-ply tape, with another implementation of step c), the result is an eight-ply tape, etc.

After step b) and/or optionally after step c), a fixation of the folding performed in the preceding step preferably occurs. If step c) is performed several times, the fixation may be carried out either after each step c), after individual steps, or even just after the final one of the steps c).

The fixation of the folding occurs, for example, by a slight pressure which can be applied via a roll, and/or thermally, i.e., by heating the tape.

The tape produced is wound up after step b) or optionally after the step(s) c). In the processes of the prior art, a (partial and uncontrolled) folding of the tape has been achieved only within the scope of said winding operation. In the process according to the invention, a tape that has already been folded completely and in a defined manner is supplied to the winding.

After step b) or optionally after the step(s) c) or after a fixation which has occurred after step b) or step c), respectively, the tape may be stretched in a manner known per se. However, the tape can be supplied to the folding process also in an already stretched form.

The tape (1) provided in step a) may be composed of at least two layers which, optionally, are coloured differently.

The tape provided in step a) may be produced according to the initially mentioned processes for the manufacture of PTFE tapes, which processes are known per se. Preferably, the tape is produced by the method according to AT-B 370.674.

The original dimensions of the tape conform to the desired dimensions of the finished folded molded body.

The molded body according to the invention may preferably be used as a material for dental floss, wherein the low tendency toward fibrillation and the uniform width/thickness properties have a particularly favourable effect.

The molded body according to the invention may contain additives such as, e.g., coloured liquid pigments free from heavy metals or abrasive filling materials in a manner known per se.

In addition, the molded body according to the invention may be coated, e.g., with wax in a manner known per se.

Below, the present invention is illustrated in further detail by the figures and examples.

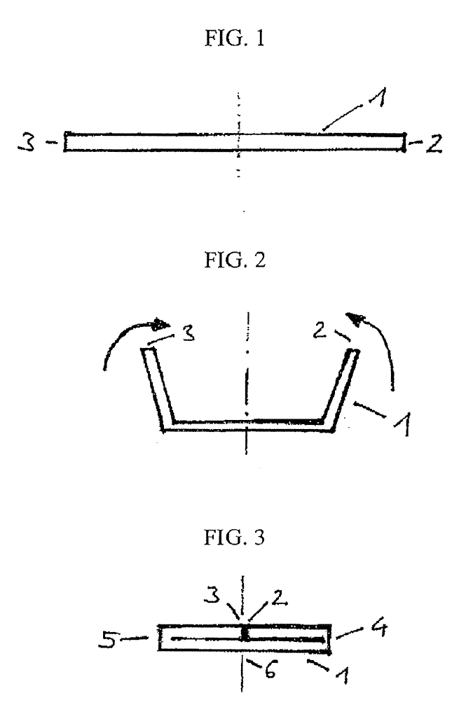

FIGS. 1 bis 5 schematically show the sequence of a preferred embodiment of the process according to the invention for the manufacture of the molded body according to the invention.

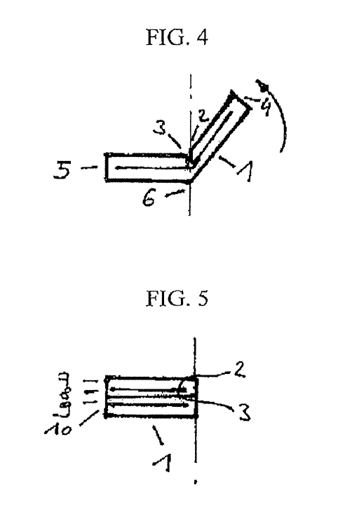

FIG. 6 shows a photograph of a cross-section of a molded body according to the invention.

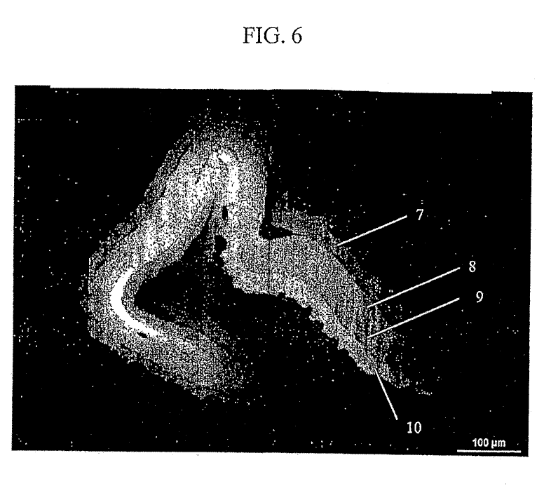

FIG. 7 shows the photograph of a cross-section of a further molded body according to the invention.

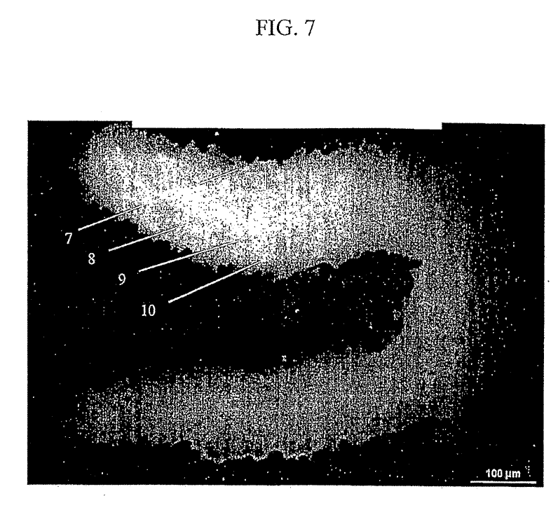

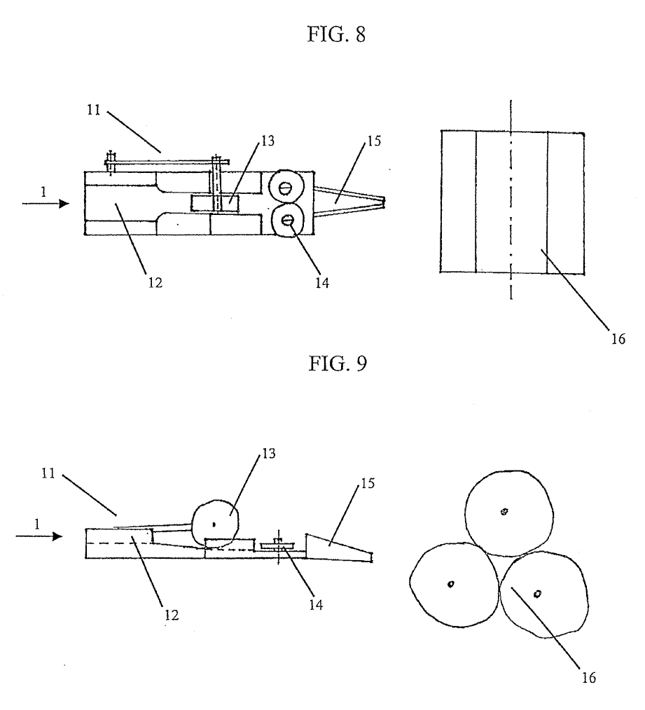

FIGS. 8 and 9 schematically show a device usable for the manufacture of the molded body according to the invention.

FIG. 1 schematically shows the cross-section of a PTFE tape 1 used as a starting material (step a)). The tape 1 exhibits a defined thickness and width and has two edges 2 and 3.

According to FIGS. 2 and 3, the tape is now folded on both edges 2,3 such that the original edges 2 and 3 end up lying adjacent to each other in the area of the longitudinal edge 6 of the tape 1 (step b)). Two new edges 4 and 5 are thereby formed.

If the process is stopped at that point, the result is a double-ply tape the original edges of which lie on the top side of the tape, in the area of the longitudinal axis. Said tape is already substantially more resistant to fibrillation than products of the prior art and nevertheless exhibits a very uniform thickness and width, respectively, across the length of the tape.

At that point, a fixation of the produced folding can be effected by slightly pressing the tape.

For the production of a four-ply tape, the previously produced double-ply tape 1 is now folded around the longitudinal axis 6 thereof (step c)), see FIG. 4. The result is a tape having four plies 7,8,9,10 (FIG. 5).

Due to the folding, the original edges 2,3 lie in the interior of said tape and are thus no longer able to negatively affect the fibrillation properties of the tape during use. After said folding, the previously formed edges 4 and 5 end up lying essentially on top of each other. The result is a tape with an excellent resistance against fibrillation and, at the same time, a very uniform width and thickness.

If step c) is repeated, i.e., the tape illustrated in FIG. 5 is refolded, the result is an eight-ply tape (not illustrated).

Upon completion of the folding process, the tape may be stretched. Finally, the folded and optionally stretched tape is wound up.

FIG. 6 shows a cross-sectional photograph of a four-ply tape produced according to the invention. The four plies 7,8,9,10 are clearly visible.

FIG. 7 shows a cross-sectional photograph of a further four-ply tape produced according to the invention. In this example, a tape made up of two differently coloured layers (red and blue, respectively) was used as the starting material. Due to the folding according to the invention, thereby a coloured layer always ends up lying on a layer of the same colour so that the inner plies 8 and 9 give the optical impression of being thicker.

A folding device 11, which is schematically illustrated in FIGS. 8 and 9, serves for the precision folding of the tape.

Reference numeral 12 thereby indicates the feed and guide area for the unfolded tape 1 supplied to the device 11. Reference numeral 13 indicates a press roll by means of which the first folding step is performed. Two stabilizing disks which, optionally, are spring-loaded and which fix and stabilize, respectively, the folding produced by means of the press roll 13 are marked by reference numeral 14. Reference numeral 15 marks a wedge-shaped area by means of which the second folding step is performed. A system of rolls, e.g., a three-high roll, is indicated by reference numeral 16, by means of which the folding produced in the wedge-shaped area 15 is fixed by pressing.

The mode of operation of the device 11 illustrated in FIG. 8 and FIG. 9, respectively, is as follows:

The tape 1 is supplied to the device 11 in the unfolded state. In area 12 of the device 11, a precise guiding of the tape within the two side walls of the area 12 is achieved. The tape is carried further toward the press roll 13. Due to the narrowing of the guide area, which is illustrated, as well as due to the fact that the tape is guided underneath the press roll 13, the two original edges 2 and 3 of the tape 1 (see FIGS. 1 and 2) first fold up laterally and subsequently fold down so that they end up lying essentially at the longitudinal axis 6 of the tape (see FIG. 3). The as-yet loose folding thus produced is stabilized by means of the stabilizing disks 14 which, optionally, are spring-loaded and which exert a slight contact pressure on the tape.

The tape folded once in this manner now gets to the wedge-shaped area 15 where the new edges 4 and 5 formed in the preceding folding step (see FIG. 3) again fold up laterally. The tape leaves the wedge-shaped area in a “V”-like shape (see FIG. 4) and is carried further to the three-high rolls 16 where the tape is first rotated by 90° when it contacts the first roll and is then guided through the system of rolls in a manner known per se, whereby the four-ply folding that has been produced is fixed as a result of the contact pressure of the rolls (see FIG. 5).

The second folding step in the wedge-shaped area 15 may optionally be repeated one or several times, whereby an 8-fold, 16-fold etc. folding is achieved.

After the folding, the tape may be stretched and processed in a manner known per se.

### EXAMPLES

A PTFE tape produced in a manner known per se and having a cut width of approx. 10 mm is supplied to the folding device illustrated in FIGS. 8 and 9 and is folded twice, whereby a four-ply molded body is formed. Subsequently, the folded tape is stretched in a manner known per se. The width of the tape folded and stretched in this manner amounts to 2.0 mm. The tape is excellently usable as a dental floss material.

What is claimed is:

1. A low-fibrillation molded body containing a tape (1) essentially consisting of polytetrafluoroethylene, characterized in that the tape is composed of at least four plies (7,8,9,10) of essentially equal width arranged essentially parallel to each other, said plies being obtainable by folding.

2. A molded body according to claim 1, characterized in that the tape (1) is composed of at least eight plies.

3. A low-fibrillation molded body containing a tape (1) essentially consisting of polytetrafluoroethylene, characterized in that the tape is folded on both edges (2,3) and, in the folded state, both edges (2,3) are located close to or at the longitudinal axis (6) of the tape.

4. A molded body according to any of claims 1 to 3, characterized in that the individual plies of the tape (1) are composed of at least two layers which, optionally, are coloured differently.

5. A molded body according to any of the preceding claims, characterized in that the tape (1) exhibits an essentially uniform width and thickness across its length.

6. A process for the manufacture of a molded body according to any of the preceding claims, comprising the steps of
a) providing a tape (1) essentially consisting of polytetrafluoroethylene, which tape has two original edges (2,3),
b) folding the tape (1) on both original edges (2,3) so that, after the folding, the original edges (2,3) end up lying essentially parallel to each other and close together, preferably adjacent to each other, and two new edges (4,5) are formed,
c) optionally at least one further folding at the longitudinal axis (6) of the tape (1) so that, after the folding, the previously formed new edges (4,5) end up lying essentially on top of each other.

7. A process according to claim 6, characterized in that, in step b), the original edges (2,3) end up lying close to or at the longitudinal axis (6) of the tape (1) after the folding.

8. A process according to claim 6 or 7, characterized in that, after step b) and/or optionally after the steps c), a fixation of the folding occurs.

9. A process according to any of claims 6 to 8, characterized in that the tape (1) is wound up after step b) or optionally after the step(s) c).

10. A process according to any of claims 6 to 9, characterized in that the tape is stretched after step b) or optionally after the step(s) c) or after a fixation which has occurred after step b) or step c), respectively.

11. A process according to any of claims 6 to 10, characterized in that the tape (1) provided in step a) is composed of at least two layers which, optionally, are coloured differently.

12. A molded body, obtainable by a process according to any of claims 6 to 11.

13. The use of a molded body according to any of claims 1 to 5 as well as 12 as a material for dental floss.
